(19) United States
(12) Patent Application Publication
(10) Pub. No.: US 2026/0134311 A1
(43) Pub. Date: May 14, 2026

(54) SYSTEMS AND METHODS FOR CENSUS-BASED MULTI-AGENT AUTONOMY AND INDIVIDUAL BEHAVIOR OPTIMIZATION

(71) Applicant: Massachusetts Institute of Technology, Cambridge, MA (US)

(72) Inventor: Tyler Paine, Bridgewater, MA (US)

(73) Assignee: Massachusetts Institute of Technology, Cambridge, MA (US)

(21) Appl. No.: 19/384,563

(22) Filed: Nov. 10, 2025

Related U.S. Application Data
(60) Provisional application No. 63/718,628, filed on Nov. 9, 2024.

(51) Int. Cl. G06N 5/043

(52) U.S. Cl. CPC G06N 5/043

(57) ABSTRACT

A method for group-level decision making via a census includes using an agent controller to determine one or more collective objectives, calculate a preference for each collective objective of the one or more collective objectives, where each preference is associated with an internal opinion, and receive an external opinion from each agent of one or more agents to form a weighted census. The method further includes using the agent controller to update the internal opinion based on the weighted census, select an option based on the internal opinion, select one or more actions corresponding to the selected option, and perform the one or more actions via the agent controller.

### CROSS-REFERENCE TO RELATED APPLICATIONS

This application is a U.S. Nonprovisional application which claims the benefit of U.S. Provisional Application No. 63/718,628, filed Nov. 9, 2024, and is hereby incorporated by reference in its entirety.

### STATEMENT REGARDING FEDERALLY SPONSORED RESEARCH

Not applicable.

### FIELD OF ART

This disclosure relates generally to autonomous device control and, more particularly, to census-based decision making in autonomous devices.

### BACKGROUND OF INVENTION

It has been premised that systems which include two or more autonomous robots which communicate (a so-called “networked multi-robot system”) are capable of completing tasks more efficiently and are more robust to failures compared with autonomous robots which are not in communication with each other (i.e., which are not networked).

For this premise to be true, however, one significant prerequisite is that the autonomous population (i.e., the two or more autonomous robots) must exhibit collective intelligence. A group of robots is considered to have collective intelligence if the group is able to complete problems such as task allocation, adaptive sampling, and formation assembly in response to environmental stimuli. Collective intelligence in multi-robot systems is typically achieved by exploiting shared information. The exploiting of shared information may, for example, be accomplished with the use of, complex neural networks which are constantly checking the state of each robot within the system. In general, more sophisticated group behaviors may be achieved by increasing the amount of communication between individuals in combination with increased sensory feedback and improved reasoning or planning at the individual robot level.

However, this level of communication comes at a significant cost. First, failure states may lead neural network based robot systems to re-evaluate the entire network and wait for each robot in the system to confirm received information. Second, the use of a centralized controller (as with most neural network and other multi-robot systems) lacks efficiency and effectiveness, often driving up the cost of operation and the time to complete a task.

### SUMMARY OF THE INVENTION

Described are concepts, systems and techniques for census-based decision making in autonomous devices.

In a first embodiment, a method for group-level decision making via a census includes using an agent controller to determine one or more collective objectives, calculate a preference for each collective objective of the one or more collective objectives, where each preference is associated with an internal opinion, and receive an external opinion from each agent of one or more agents to form a weighted census. The method further includes using the agent controller to update the internal opinion based on the weighted census, select an option based on the internal opinion, select one or more actions corresponding to the selected option, and perform the one or more actions via the agent controller.

In some embodiments, determining the one or more collective objectives includes determining the one or more collective objectives via one or more nearby agent of the one or more agents.

In some embodiments, determining the one or more collective objectives includes receiving the one or more collective objectives from another agent of the one or more agents.

In some embodiments, the method for group-level decision making via the census includes calculating, via the agent controller, utility functions for each action of the one or more actions, determining an pareto optimal solution for the selected option, and adjusting the one or more actions associated with the selected option based on the pareto optimal solution.

In some embodiments, each opinion comprises a positive or negative opinion associated with a particular option.

In some embodiments, the method includes determining an optimization mode of a plurality of optimization modes, where the plurality of optimalization modes comprise an increase of sampling efficiency with a decrease of dangerous scenarios, competitive-based point collection, increase of intercept efficiency in a high-value as set protection scenario.

In some embodiments, the method includes detecting an indication of an emergency scenario impacting at least one agent of the one or more agents, transmitting the indication of the emergency scenario to each agent of the one or more agents, and executing a transition from normal operation to emergency operation based on the indication.

In some embodiments, each agent is associated with individual parameters and collective parameters, where the individual parameters include a current state of operation and an individual behavior optimization value, where the collective parameters include the internal opinion and a collective behavior optimization value.

In some embodiments, the method includes determining one or more shared actions based on the weighted census, determining one or more groups to perform a respective shared action, wherein the one or more groups include a subset of the one or more agents, and communicating each respective shared actions to each respective group.

In yet another embodiment, a system for group-level decision-making and behavior optimization for individual decision-making, where the system includes one or more agents, where each agent includes an agent controller and is communicatively coupled to one another, where each agent receives sensor data via one or more sensors associated with a respective agent, generates one or more options based on the sensor data, where each option is associated with an action, generates one or more internal opinions based on the one or more options, where each internal opinion is associated with a respective option of the one or more options, transmits the one or more internal opinions and the one or more options to each agent of the one or more agents, generates a census for group-level decision-making in combination with the other agents of the one or more agents, where the one or more agents communicate with one another via the census to reach a decision on an option to pursue, selects an active option based on the census, selects an action corresponding to the active option, and performs the action via the agent controller.

In some embodiments, each agent generates the one or more internal opinions via an opinion manager engine.

In some embodiments, each option includes a plurality of parameters to influence behaviors of the respective agent.

In some embodiments, each agent associates with one another to form one or more groups, where each group performs related actions based on the census.

In some embodiments, the one or more agents achieve a census on a selected option based on the census and cascade particular opinions to particular groups and each agent within the particular groups.

In some embodiments, wherein each option comprises a desired heading and desired speed.

In some embodiments, the one or more agents generate one or more tasks based on the sensor data and allocate a set of tasks to each group, wherein a respective set of tasks includes a subset of the one or more tasks.

In yet another embodiment, a method to adaptively change a census model includes identifying, via an agent controller, a plurality of collective rewards associated with a goal via the census model from one or more agents, determining a first improvement in census model to increase collective rewards, determining a second improvement in an individual optimization model to increase an individual reward, wherein the individual reward is of the plurality of collective rewards, adjusting one or more parameters of the census model based on the first improvement, and adjusting one or more parameters of the individual optimization model based on the second improvement.

In some embodiments, the method to adaptively change the census model includes identifying one or more errors in executed actions associated with a respective agent, determining a third improvement in a control algorithm, and adjusting one or more parameters of the control algorithm based on the third improvement.

In some embodiments, the identification processes are carried out periodically, randomly, in a set order, or any combination thereof.

In some embodiments, the one or more agents include marine robots, terrestrial robots, aerial robots, extraterrestrial robots, digital robots, or any combination thereof.

It is appreciated that the concepts, techniques, and structures disclosed herein may be embodied in other ways, and that the listing of certain embodiments above does not limit the inventive scope of this disclosure.

### BRIEF DESCRIPTION OF THE DRAWINGS

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principals of the concepts described herein. Like reference numerals designate corresponding parts throughout the different views. Furthermore, embodiments are illustrated by way of example and not limitation in the figures, in which:

FIG. 1 is a block diagram of a network of robots;

FIG. 2A is a block diagram of a network of robots having communication paths therebetween;

FIG. 2B is a block diagram illustrating behavior and states of one or the robots in the network of FIG. 2A;

FIG. 2C is a block diagram illustrating choice dynamics of the robots in the network of FIG. 2A and decision making behavior of one or the robots in the network of FIG. 2A;

FIG. 3 is a flow diagram of a process for autonomous device operation;

FIG. 4 is a flow diagram illustrating a process for adaptively changing a census model;

FIG. 5 is a flow diagram illustrating a process for group-behavior census with individual-optimization model for each agent in a group of agents;

FIG. 6 is a block diagram of an example opinion manager engine;

FIG. 7 is a block diagram of an example scenario in which one or more agents are assigned a collective objective;

FIG. 8 is a block diagram of an example scenario in which one or more agents are tasked with protecting a high-value target from one or more opposition agents;

FIG. 9 is a block diagram of an example scenario in which agents are assigned to a particular team and tasked with protecting an object;

FIG. 10 is a simplex graph of changing opinion as a function of an exploit option v. a migrate option v. an explore option; and

FIG. 11 is a network diagram of the example scenario describe above in conjunction with FIG. 7.

### DETAILED DESCRIPTION

Before describing the concepts, systems and techniques for providing a network which includes a plurality of autonomous robots which utilize census-based decision making to perform a task or achieve a goal, some terms are defined.

As used herein, the term “agent” refers to any type of autonomous robot including, marine vehicles, terrestrial vehicles, aerial vehicles, space vehicles, cyber vehicles or any other type of autonomous machine or autonomous vehicle. Such agents may be manned or unmanned autonomous robots.

The networks described herein comprise a plurality of agents. In some instances, a subset of such plurality of agents may form a subgroup and such a subgroup may form their own network (also sometimes referred to as a subnetwork). Thus, in some instances, references made hereinbelow to “a network” may refer to individual groups (or networks) of agents within a larger network of agents. Stated differently, a network may comprise two or more subnetworks. Further, such subnetworks may be formed out of (or originate from or be divided from) an initial network. Also, in some instances, agents from two or more networks may join to form a larger network.

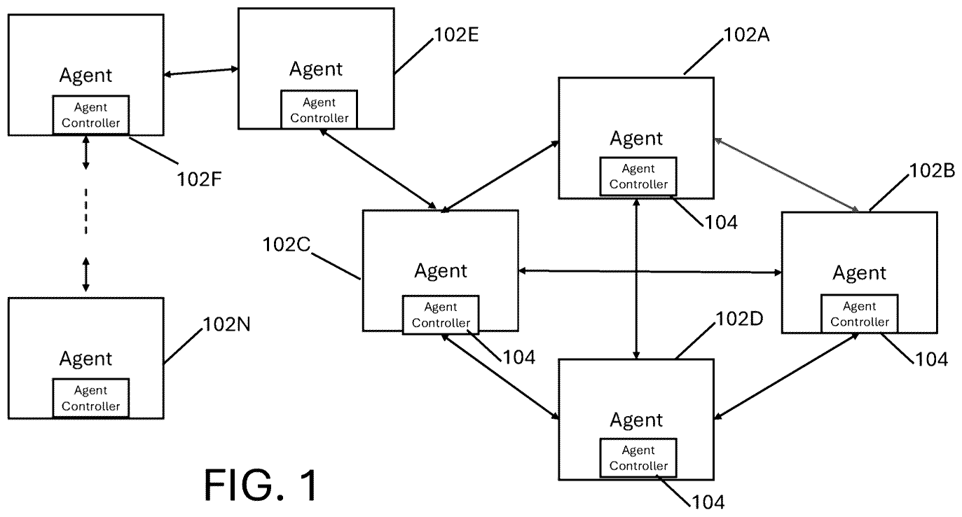

With the foregoing in mind, and referring now to FIG. 1, a multi-agent autonomous network 100 (“network 100”) comprises one or more autonomous agents 102A-N, generally denoted 102. Each agent 102 corresponds an autonomous machine (also sometimes referred to as an autonomous vehicle). Each agent 102 comprises or is associated with a respective agent controller 104. The number of agents 102 that are associated with the network 100 is not limited in any way by the embodiments herein and as such, any number of agents 102 may operate within the network 100. Each agent 102 is capable of communication with one another. Such communication may be direct or indirect. In some embodiments, each agent 102 may use a broadcast-only communication mechanism, where each agent 102 broadcasts the information necessary to each respective agent 102 without the requirement of receiving feedback. In this way, the network 100 may facilitate quick and effective communication within a multitude of different mediums (e.g., air, vacuum, water, smoke, etc.), such that information is quickly transferred to, between and among agents 102.

The network 100 may include one or more different types of agents 102. That is, the one or more different types of agents 102 may include a marine type (e.g. an autonomous underwater vehicle (AUV), a terrestrial type (e.g. an unmanned ground vehicle (UGV) such as a car, truck, tracked robot, or other terrestrial vehicle), an aerial type (e.g. an unmanned aerial vehicle (UAV), a space (or vacuum) type (e.g., a UGV or AUV capable of operating in space or a space-type environment, a cyber type, and any other additional types of autonomous machine. In some embodiments, the makeup of the type of agents 102 may include all the same type of agent 102 (e.g., all marine types, etc.) or a combination of multiple different types of agent 102. Each agent 102, regardless of type, may communicate with another agent 102 of the same or different type. In certain embodiments, each agent controller 104 may include a communication module configured to enable data exchange between one or more agents 102 using one or more wireless communication protocols. The communication module may employ Bluetooth® or Bluetooth Low Energy (BLE), Wi-Fi, and radio frequency (RF) protocols such as IEEE 802.11 B/G/N for long-range. In some embodiments, the system may dynamically switch or combine communication modes based on factors such as signal strength, data priority, or power availability to maintain robust and efficient network connectivity. Furthermore, each agent 102 may utilize Transmission Control Protocol (TCP) to send messages locally between each agent 102, while also utilizing a User Datagram Protocol (UDP) to send messages to other groups of one or more agents 102 via the IP address and port of the receiving agent(s) 102. That is, each agent 102 may communicate locally with other agents 102 in close proximity and with other agents 102 farther away using different protocols.

Each agent 102 is configurable to communicate with any number of additional agents 102 within a particular distance (e.g., a particular radius) of the respective agent 102. Such a distance may be determined or defined by the range of the particular type of communication system included in the agent. Each agent 102 may communicate individually with the other one or more agents 102 directly or as part of a wider network. That is, the network 100 may be a fully connected or partially connected network, where each agent 102 need not be able to communicate with the entire set of agents 102 to function correctly. That is, a subset of the one or more agents 102 may form into a group (e.g. a sub-network of network 100) to facilitate a particular aspect of an objective and/or based on environmental obstacles and/or physical stimuli.

An example of a fully connected network includes the agents 102a-d, where each agent 102 a-d may communicate with one another without using an intermediary agent. That is, a partially connected network, as shown by agents 102e, 102f, and 102n, includes one or more agents 102 that may use an intermediary agent to communicate with a indirectly connected agent. For example, if agent 102b attempted to broadcast information to agent 102f, agent 102b may use the connection between agent 102c, 102e, and 102f to complete the broadcast. In the event that one or more sets of connected agents 102 disconnect (e.g., if the connection between agent 102c and 102e is severed), each individual network group may function independently from one another. That is, a first network formed between the agents 102a-d and a second network between 102e, 102f, and 102n may function normally.

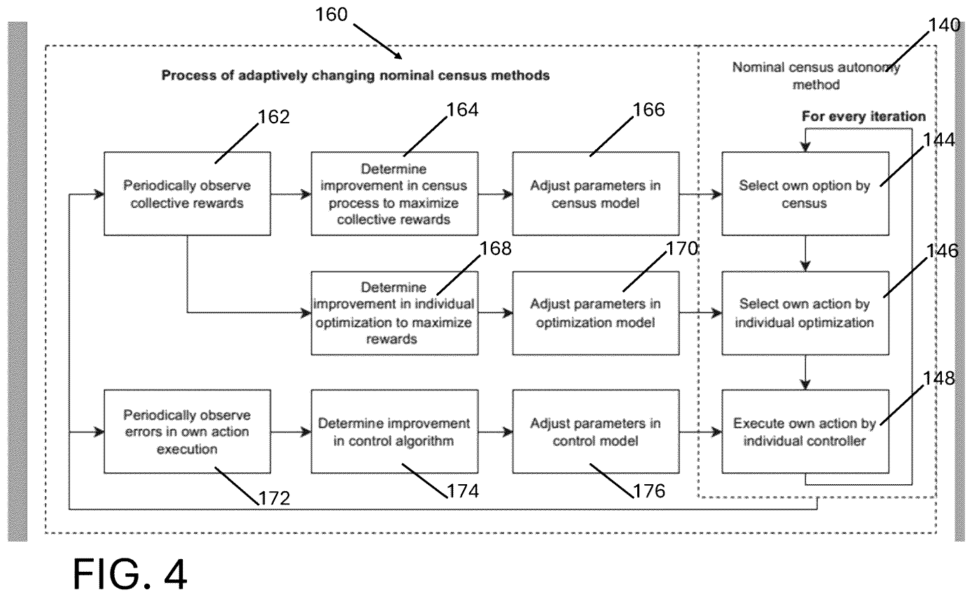

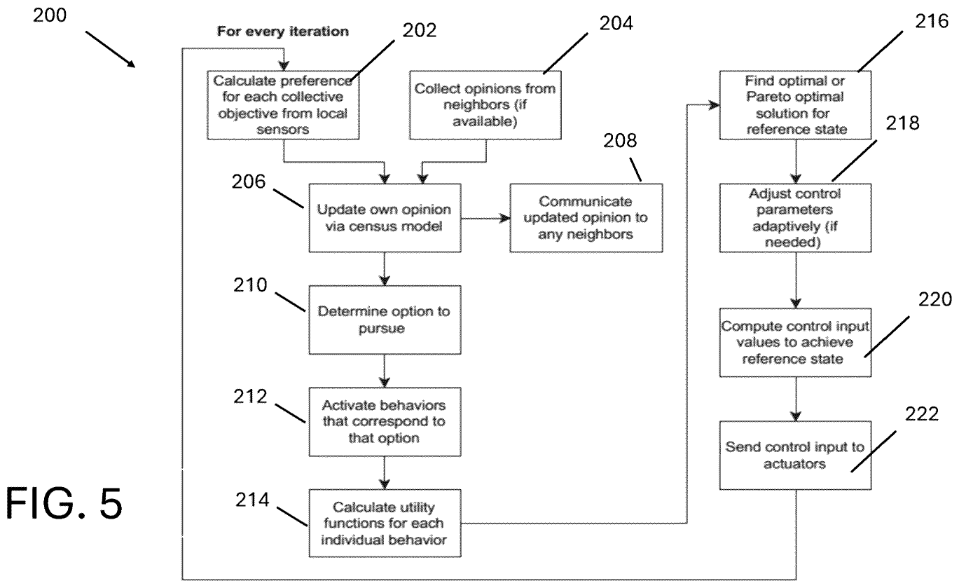

Each agent 102 receives a set of collective objectives or instructions that may lead each agent 102 in executing actions or decisions. The one or more agents 102 may modify the collective objectives, via each agent controller 104, based on present conditions in the environment, past or future actions planned or suggested by the one or more agents 102, or from an external source. In operation, and in general overview, each agent 102 communicate with one another to perform or facilitate collective decision-making while promoting individual behaviors specific to each agent 102 using the principle of census (i.e., a weighted count of the inputs from each agent 102), for collective decision-making coupled with multi-objective behavior selection (and ideally, multi-objective behavior and in some instances multi-objective behavior optimization) for individual decision-making. That is, the principle of census is used to balance multiple behavioral goals by coordinating trade-offs among network objectives and the objectives of individual agents. The collective decision of the one or more agents 102 may be a consensus, or when all or a majority of agents 192 agree to a specific option for a group of one or more agents 102 to pursue. Another option is dissensus, where the one or more agents 102 may allow disagreement, such that the one or more agents 102 do not all agree on an option and instead agree upon which of the agents 102 should be assigned to two or more teams to each perform one of the options. As described herein, using a census approach, behavior of agents in the network may be adjusted (and in some embodiments, continuously adjusted) to achieve one or more goals or perform one or more tasks. This will be discussed further below in FIGS. 4 and 5.

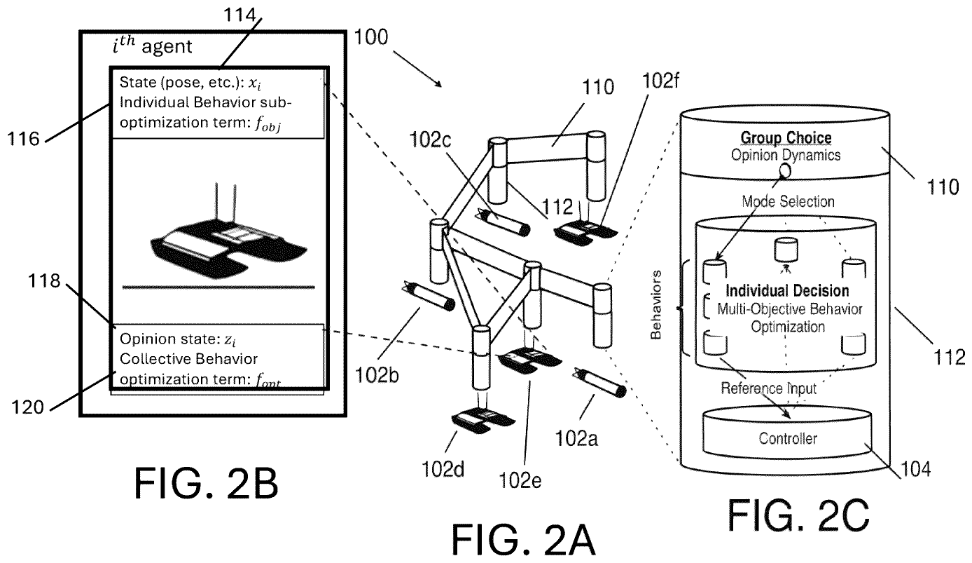

With the foregoing in mind, FIG. 2A illustrates the network 100 with the one or more marine agents 102a-102c and one or more terrestrial agents 102d-102f. In terms of decision making, there are different paths of communication which take place over or within network 100 between each agent 102 and within each agent 102. For clarity and ease of explanation, in this example embodiment, two different paths of communication are illustrated in FIG. 2 with the two different types illustrated as paths. A first path corresponds to a group communication path 110 and a second path corresponds to an internal communication path 112.

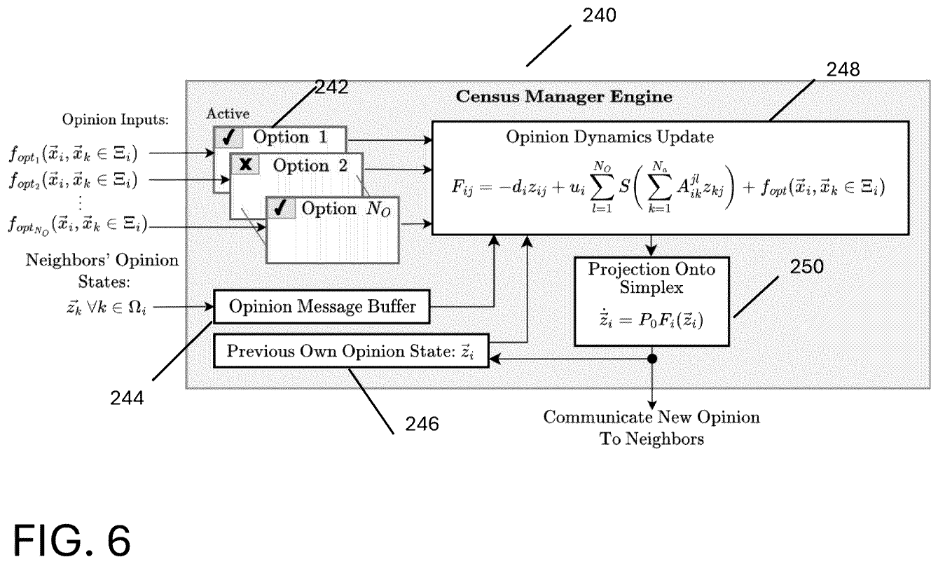

The group communication path 110 may include any number of agents 102 and any amount of groups that are made up from the agents 102. In the group communication path 110, the one or more agents 102 may communicate with one another to achieve a particular objective (e.g., a collective objective). That is, the one or more agents 102 may collaborate to increase (and ideally maximize) a global feedback reward and/or decrease (and ideally minimize) a global resource cost when achieving the particular objective. By way of example, each agent 102 of the one or more agents 102 may propose a particular option to each nearby agent 102 in the group communication path 110. The particular option relates to increasing of a feedback reward and/or decreasing resource cost. Once the particular option is broadcast to each nearby agent 102, each nearby agent 102 may generate an opinion regarding the particular option as part of a collective census to determine if the particular option can lead to increasing (and ideally maximizing) the feedback reward and/or decreasing (and ideally minimizing) the resource cost. Each opinion is presented as a weighted average of each agent's 102 preference for undertaking a particular action, which is presented as a scalar value. This is to avoid a binary choice system, where each agent can only respond with a “Yes” or “No”. By way of example, if there are two different decisions with respect to a certain option, then each agent 102 may express the associated opinion with a single number scalar value as to which decision is preferred by the respective agent 102. Furthermore, if there are three different options, then each agent 102 may express the associated opinion with two scalar values to indicate preference. The specifics regarding the opinion selection and generation will be described below in FIG. 6.

Each agent 102 may include one or more parameters each associated with the group communication path 110 and the internal communication path 112. That is, the one or more parameters may include a current state 114, an individual behavior sub-optimization term 116, an opinion state 118, and a collective behavior optimization term 120. The current state 114 may represent kinematic states (e.g., pose and velocities) in addition to other states such as fuel/battery level. The individual behavior sub-optimization term 116 is modeled as an optimization problem that is solved by interval programming. These parameters will be further explored below in FIGS. 4 and 5.

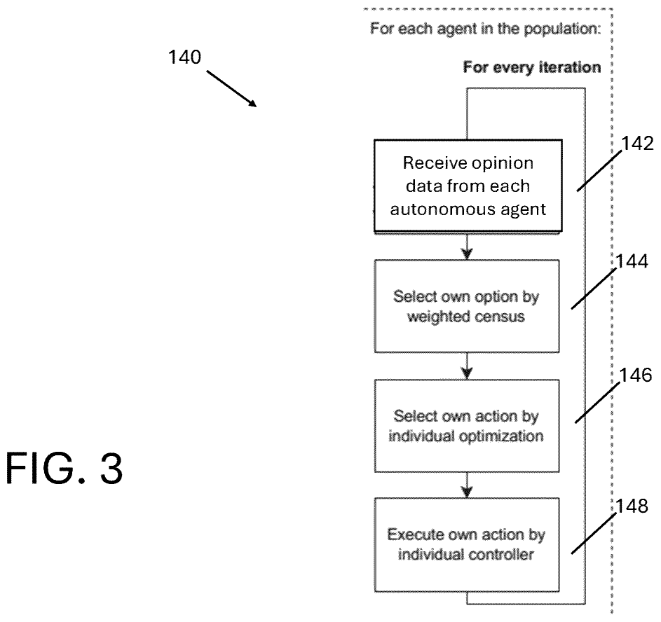

FIGS. 3-5 are flow diagrams showing illustrative processing that can be implemented within a system such as the illustrative network 100 described above in conjunction with FIGS. 1 and 2A and, more particularly, within one or all agents 102 described above in conjunction with FIGS. 1 and 2A.

Rectangular elements (typified by element 142 in FIG. 3s), are herein denoted “processing blocks,” and represent computer software instructions or groups of instructions. Alternatively, the processing blocks may represent steps or processes performed by functionally equivalent circuits such as a digital signal processor circuit or an application specific integrated circuit (ASIC). The flow diagram does not depict the syntax of any particular programming language, but rather illustrates the functional information one of ordinary skill in the art requires to fabricate circuits or to generate computer software to perform the processing described. It should be noted that many routine program elements, such as initialization of loops and variables and the use of temporary variables are not shown. It will be appreciated by those of ordinary skill in the art that unless otherwise indicated herein, the particular sequence of blocks described is illustrative only and can be varied without departing from the spirit of the concepts, structures, and techniques sought to be protected herein. Thus, unless otherwise stated the blocks described below are unordered, meaning that, when possible, the functions represented by the blocks can be performed in any convenient or desirable order.

With the foregoing in mind, method 140 shown in FIG. 3 illustrates example actions of each agent 102 during operation. At block 142, a respective one of the plurality of autonomous agents in a network of autonomous agents may receive opinion data from other autonomous agents with respect to an option proposed by the respective one of the autonomous agents. For example, a respective autonomous agent 102a (FIGS. 1, 2A) may receive opinion data from other autonomous agents (e.g. one or more of autonomous agents 102b-102d in FIGS. 1 and 2A) with respect to an option proposed by agent 102a.

As discussed above and herein, the option is a representation of a set of actions for the respective agent (such as agents 102 in FIGS. 1 and 2) to undertake in response to the increase of collective rewards with respect to the collective objectives at large. The opinion data from each agent forms into a weighted census associated with the option via a census model, where the weighted census provides a group choice (e.g., a strongest opinion) of the best option to proceed with. The census model will be further discussed below in FIG. 4.

At block 144, the respective agent may select a particular option based on the weighted census. The weighted census is a collection of opinions of each agent in relation to achieving a specific collective objective. That is, when the respective agent (e.g., agent 102a) is attempting to achieve a sub-objective and/or increase (and ideally maximize) a collective reward from completing the specific collective objective, each agent (e.g., agent 102b, 102c, 102d) nearby the respective agent may provide one or more opinions, where the opinions form the weighted sensis. As such, there may be multiple weighted censuses corresponding to multiple options to achieve multiple (or the same) collective objective at any given time.

At block 146, the respective agent may select one or more actions to carry out the selected option based the current state 114 and the individual behavior sub-optimization term 116. The one or more actions may include direction, heading, speed, depth, and/or any combination thereof that allow the respective agent to increase (and ideally maximize) the collective reward. Individual optimization will be further discussed below in FIG. 4. At block 148, the respective agent may execute the selected actions via a respective agent controller (such as the agent controller 104 in FIGS. 1 and 2). The respective agent controller 104 may determine one or more actuators of the respective agent 102 to adjust based on the selected actions and additional control optimization. Control optimization will be further discussed below in FIG. 4.

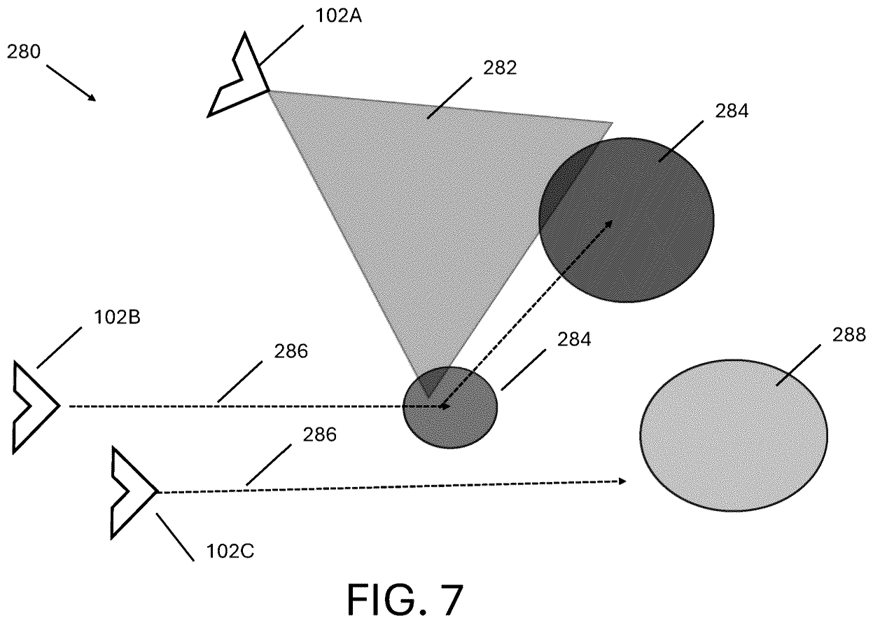

It should be understood that the one or more agents 102 may separate into one or more teams to handle particular sub-objectives of the overall collective objective(s). These teams may be pre-selected or may form ad-hoc based on the needs of a specific team with a subset of the one or more agents 102. As such, it is important to constantly evaluate and improve the collective response via the census model and, on an individual basis, each agent 102 may evaluate and improve its own individual actions via the individual optimization model and the control model. Collective rewards are products of the environment and related collective objectives and how the objectives relate to the environment. As will be discussed below in FIG. 7, an example collective objective and related environment could be the detection and collection of algae blooms within a river flowing through a major city center. To achieve this objective, the one or more agents 102 may be divided into multiple teams, where each team evaluates each option for each agent 102 within the respective team based on an exploration value, an exploitation value, and a migration value. The exploration value is a representation of a current traveled distance and/or battery consumption, the exploitation value is a representation of a range to the nearest available sample with a maximum reward value, and the migration value is a representation of a particular environmental factor or event that necessitates the migration of the one or more agents 102 to avoid or respond to the environmental factor or event. Further details will be provided below in FIG. 7.

Turning to FIG. 4, when a particular agent (such as the agent 102a) is joining a particular team (e.g., an exploration team, an exploitation team, etc.), that particular agent may adjust its behavior to better fit the needs of the particular team. That is, the particular agent may seek to become a conforming “teammate” with respect to the other agents (such as a team including the agents 102b, 102c, and 102d) within the particular team and the objective of the particular team. To accomplish this, the particular agent may be constantly adjusting (or ideally optimizing) its own behavior and actions, while also assisting in the optimization of the collective-rewards in the census model. With the foregoing in mind, FIG. 4 is a method 160 illustrating adaptively changing the census model, the individual optimization model, and the control model, which assists in the execution of an abbreviated method 140 as discussed in FIG. 3.

At block 162, a particular agent (such as agent 102a in FIGS. 1 and 2) may periodically observe the collective rewards received by an associated team and/or all the one or more agents (such as agents 102b, 102c, 102d . . . 102n). Additionally, the particular agent may periodically observe promised or potential rewards offered in response to a specific sub-objective being completed. That is, the particular agent may identify one or more unearned collective rewards due to errors in the weighted census decision making, individual behavior errors, and control errors.

At block 164, the particular agent may determine improvements to the census model to increase (and ideally maximize) a collective rewards based on the observation at block 162. These improvements are represented by the collective behavior optimization term 120 and may include biases related to the environment associated with the collective rewards, biases related to particular paths of success or failure (e.g., if one agent wants to proceed in a certain direction), better opinion weighting such that rewards are increased (and ideally maximized) a, and any other additional improvements to the census model.

Based on the determined improvements at block 164, at block 166, the particular agent may adjust one or more parameters of the census model. This adjustment to the census model then directly influences the selection of the option at block 144 of FIG. 3. This cycle continues for each iteration (e.g., proposed option).

At block 168, the particular agent may determine improvements in individual actions to increase (and ideally maximize) rewards based on the observation at block 162. These improvements are represented by the individual behavior sub-optimization term 116 and may include a pareto optimal solution for a reference trajectory, nominally desired heading and speed, given historical and objective functions of all active behaviors. The individual behavior sub-optimization term 116 is U, as described in Equation 1 below:

$${r}_{1}^{*} , {r}_{2}^{*} … {r}_{m}^{*} = arg max U \qquad Equation 1$$

In Equation 1, r is each decision variable, m is a specific decision, and U is described in Equation 2 below:

$$U = {e}_{{z}_{ma x}}^{T} \overline{{A}_{c}} W \{ \begin{matrix}{f}_{1} ( {r}_{1} , {r}_{2} … {r}_{m} ) \\ {f}_{2} ( {r}_{1} , {r}_{2} … {r}_{m} ) \\ ⋮ \\ {f}_{{N}_{active}} ( {r}_{1} , {r}_{2} … {r}_{m} )\end{matrix} \qquad Equation 2$$

The matrix A̅_̅{̅c̅}̅ is the mapping of all active behaviors to the number of options.

$${e}_{{z}_{m ax}}^{T}$$

corresponds to the option with the most positive input (where T is the transpose operator, and

$${e}_{{z}_{m ax}}^{T}$$

is the unit vector with a 1 in the index of the strongest opinion, or the largest value in z, and 0 elsewhere) and the diagonal weighting matrix associated with each option, W, is described in Equation 3 below:

$$W = diag ( {w}_{1} , {w}_{2} , … , {w}_{q} ) \qquad Equation 3$$

That is, where w_{q} is each weight associated with an opinion from each agent within the collective group.

These observations may include the amount of the collected reward compared to the potential upper limit of the collective reward, the agent's state in the environment, the data coming from each agent's sensor readings and if its aligning with the promised reward, or any combination of each. By way of example, if the particular agent takes an action to charge its battery with solar power, the particular agent may observe if the charging period was too long or short based on the collected reward. The particular agent may communicate this to the one or more nearby agents.

At block 170, based on the determined improvements at block 168, the particular agent may adjust one or more parameters of the individual optimization model. That is, the particular agent may incorporate the individual behavior sub-optimization term 116 to update the individual optimization model, such that future actions are more efficient and lead to an increased reward output. This adjustment to the individual optimization model may directly influence the selection of the one or more actions at block 146 to carry out the selected option at block 144. Each action of the one or more actions is associated with a desired set of parameters of the particular agent to carry out the selected option. By way of example, a particular action may include a desired heading and desired speed to complete the task associated with the selected option. This cycle continues for each iteration (e.g., proposed option).

At block 172, the particular agent may periodically observe errors in the one or more actions carried out by the particular agent in response to the selected option. The errors may include wasted battery/fuel as a result of extraneous movement, inaccurate movement based on the one or more actions, and/or any actions of the particular agent that result in an undesired outcome. That is, the particular agent may compare one or more observations about the state (e.g., latitude, longitude, state of actuators) to a desired trajectory/movement.

At block 174, the particular agent may determine improvements to the control model, where the control model is responsible for translating the selected one or more actions into tangible change in the operating conditions of the particular agent. By way of example, the control model may determine a best heading and a best speed of the particular agent to achieve the desired heading and desired speed associated with one or more selected actions associated with the selected option in FIG. 3. The improvements to the control model may include biases based on the environment conditions, adjustments to the power sent to actuators from damage or overuse of the particular agent, or any other changes to influence future movement/actions of the particular agent.

At block 176, based on the determined improvements at block 174, the particular agent may adjust one or more parameters of the control model. The control model may dictate specific mechanical and electrical actions to undertake to complete the selected option. This cycle continues for each iteration (e.g., proposed option).

With the foregoing in mind, FIG. 5 is a method 200 illustrating the group-behavior census model coupled with individual-optimization model for each agent 102. The method 200 is executed by the agent controller 104 associated with each agent 102. As such, the following description of method 200 will be from the perspective of a singular agent 102. However, in some embodiments, multiple agents 102 may collective perform the steps of the method 200.

At block 202, the agent (such as agent 102a) may calculate an opinion for each collective objective. Each collective objective is associated with objective data from one or more sensors associated with the agent and/or objective data from the one or more sensors associated with multiple agents (such as agents 102b, 102c, 102d . . . 102n) within the same team and/or network as the agent. As discussed above, each opinion is represented by a scalar value indicative of a specific preference towards a set of actions (e.g., an option) to achieve the collective objective. In some embodiments, the agent calculates the opinion based on its own potential actions. Also, the agent may calculate the opinion based on potential actions undertaken by nearby agents in the same group and/or network as the agent. The options (and associated actions) associated with each collective objective may incorporate the surrounding environment, status of nearby agents, status of the collective objective, reward feedback from the completion of a collective objective, and any additional information that informs the actions of the agent 102.

At block 204, the agent may collect the opinions associated with nearby agents 102. That is, the agent may broadcast to the nearby agents (such as agents 102b, 102c, and 102d) that the agent wants to select a specific option to achieve a collective objective. Based on this specific option, the nearby agents may provide one or more opinions to the agent.

At block 206, the agent may update its respective opinion based on the census model. As discussed above, the census model is a collection of the opinions of each agent (such as agents 102b, 102c, 102d . . . 102n) indicating a preference for a specific action of the agent to achieve a specific collective objective. As such, the census model may generate multiple weighted censuses corresponding to multiple options to achieve multiple (or the same) collective objective at any given time. Further description of opinion management for each agent will be discussed below in FIG. 6. At block 208, the agent may communicate its updated opinion to the nearby agents. That is, the nearby agents may receive the updated opinion of the agent to influence future preferences and decisions made by the nearby agents.

At block 210, the agent may determine a particular option to pursue based on its updated opinion. That is, the agent may propose multiple options to proceed with achieving the collective objective. Based on the particular option, at block 212, the agent may activate one or more behaviors that correspond with the particular option. By way of example, the options available to the agent may include a searching option, an exploitation option, and/or a migration option. The one or more behaviors of the agent may exist as a sub-set of the collective behaviors of the group associated with the agent to achieve a particular collective objective. For example, the behaviors of the agent may be represented as an action to take to fulfill the selected option, such as the option for “migration” leading to a behavior of the agent being movement towards a specific area/region. In another example, the option for “exploiting” may lead to the agent selecting a behavior that constitutes moving to a specific waypoint to extract algae bloom samples. It should be understood that the above listed behaviors is with respect to one of the scenario above of finding and collecting algae bloom samples. The behaviors listed herein are not limited to searching, exploiting, or migration, and may constitute any response to a particular option for achieving the collective objective (or a sub-objective of that collective objective).

For each behavior, at block 214, the agent may calculate a utility function for each individual behavior. Calculating utility functions is a product of the autonomous group-decision making that differentiates itself from traditional neural network action modeling. That is, using a neural network to model potential actions and lead decision making involves using extremely general models with many parameters. To reduce the number of parameters and allow the focus to shift to individual goals (as part of a larger collective objective), the agent 102 may generate utility functions that map action spaces to utility with far fewer parameters. This reduces the decision space, allowing for more streamlined operation and ease of communication.

Based on the utility functions calculated at block 214, at block 216, the agent may determine an optimal or pareto optimal solution to carry out the selected option to achieve the particular objective. To achieve the determined optimal solution, the agent may change the actual execution of control inputs (e.g., activating an actuator), such that the actual trajectory of the agent more closely aligns with the determined pareto optimal solution.

At block 218, the agent may adaptively adjust the control model described in FIGS. 3 and 4 to achieve the determined optimal solution. This step is substantially similar to the step performed at block 176 of FIG. 4. The adaptive adjustments to the control model may include adjusting the electromechanical functioning of the agent (e.g., power sent to an actuator, angle of movement, sensor settings, etc.).

At block 220, the agent may compute one or more control input values associated with one or more control inputs based on the adjusted control model to perform the determined optimal solution. The control input values may include voltage levels, rotation values, speed values, movement values, or any other value that directly impacts the physical control of the agent 102. At block 222, the agent may send the one or more control inputs to its actuators (not shown in FIG. 1 or 2) to perform the determined optimal solution.

With the foregoing in mind, FIG. 6 is an example opinion manager engine 240 utilized by a respective agent controller (such as the agent controller 104) of an agent (such as the agent 102a) to determine an updated opinion for one or more options 242 associated with a nearby agent (such as agent 102b) to achieve a collective objective. That is, the opinion manage engine 240 may include the one or more options 242, where each option is associated with a particular opinion (represented as a scalar value) from the agent. The opinion manger engine 240 may include an opinion message buffer 244 to handle the asynchronous communication between the agent and the nearby agent. As discussed above, communication between the agent is performed via a broadcast without a confirmation of receipt from the receiving nearby agent. As such, the opinion manager engine 240 may include the opinion message buffer 244 to ignore outdated opinions from nearby agents and ensure that relevant opinions are used to determine the opinion of the agent. The opinion manage engine 240 may include a previous opinion state 246 associated with the agent. Based on the one or more options 242, the pertinent opinions fed via the opinion message buffer 244, and the previous opinion state 246 of the agent, the opinion manager engine 240 may use an opinion dynamics update processor 248 to update the opinion of the agent. The opinion dynamics update processor 248 uses the function described below in Equation 4:

$${F}_{ij} = {d}_{i} {z}_{ij} + {u}_{i} {\sum }_{l = 1}^{{N}_{o}} S ( {\sum }_{k = 1}^{{N}_{a}} {A}_{ik}^{jl} {z}_{kj} ) + {f}_{opt} ( \vec{{x}_{i}} , \vec{{x}_{k}} ∈ {Ξ}_{i} ) \qquad Equation 4$$

That is, dᵢ is a tunable parameter that represents the resistance the i^{th} agent has to changing opinions and uᵢ is tunable parameter that represents how much attention, or weight, the i^{th} agent gives to its nearby agent's opinions. zᵢⱼ is vector representative of the opinion of the i^{th} agent about the j^{th} option. S is a saturating function (e.g., such as a sigmoid function). In the model, a linear resistance to forming strong opinions competes with positive feedback from neighbors' opinions and exogenous input. The adjacency tensor that captures network interactions is denoted as A with entries

$${A}_{ik}^{jl}$$

that parameterize the influence from the k^{th} agent's opinion about option l on the i^{th} agent's opinion about option j. Finally, fₒₚₜ is the individual input from i^{th} agent about its option preferences. That is, the individual agent's preference for the group choice is modeled as a nonlinear dynamical system of opinions, where each option has a designed input fₒₚₜ. The input fₒₚₜ may be computed using locally known information, where the information includes the state of the agent and any opinion information shared between nearby agents. The specific form of fₒₚₜ may depend on the collective objectives. The opinion manager engine 240 may update the previous opinion state 246 based on the updated opinion.

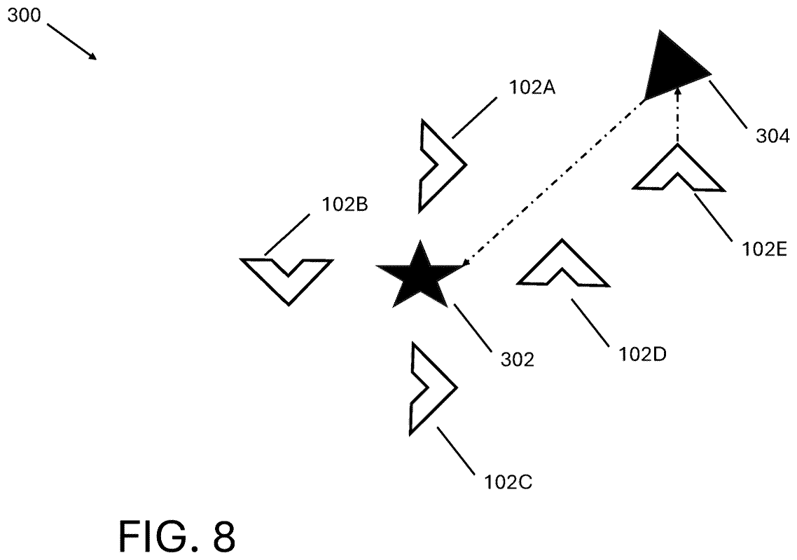

The opinion manager engine 240 may then project its updated opinion onto a simplex graph (described herein at FIG. 8) via a projection module 250 and communicate its updated opinion to nearby agents. The projection onto the simplex graph is described below in Equation 5, where \vec{z} is the previous opinion state associated with the agent:

$${\vec{z}}_{i} = {P}_{0} F ( {\vec{z}}_{i} ) \qquad Equation 5$$

With respect to FIGS. 1 and 2, It should be noted that multiple census may occur simultaneously, since each agent 102 may determine that a particular option should be pursued to increase (and ideally maximize) the collective reward. Since there is no centralized controller to receive the responses from each agent 102, disagreements between the one or more agents 102 may pose issues and cause issues to arise. However, this disagreement is useful in the decentralized autonomous group allocation and exploration. That is, the one or more agents 102 that believe “exploring” is a better option than “searching” may be grouped together. It should be understood that while the one or more agents 102 may disagree on the options presented by a particular agent 102, the multiple instances of censuses allow for consensus to occur even among agents 102 that are disagreeing on a different topic. This is due to each agent 102 using the census being able to reason individually about each option, separately, even when the census is designed such that the group forms a consensus of one option and a dissensus about other options. This is also a product of the decentralized nature of the one or more agents 102, as each agent 102 is broadcasting to one another without requiring an acknowledgement of receipt.

With the foregoing in mind, FIG. 7 illustrates an example scenario 280 in which one or more agents 102A-C are assigned a collective objective. As described above in the discussion of FIG. 4, the example scenario 280 may include a set of objectives associated with the surrounding environment, where in the scenario 280 it is the detection and collection of algae blooms within a river flowing through a major city center. Here, agent 102A is on a team focused on performing search options 282 to find one or more interest sites 284 for potential extraction to be handled by a team focused on extracting the algae blooms. Here, agents 102B and 102C are on a team focused on these potential extractions and perform actions 286 to achieve their sub-objective (extraction). By way of example, the agent 102A is attempting to collect the increased reward for identifying potential extraction sites via its respective opinion manager engine 240 in context of executing the steps of FIGS. 3, 4, and 5. That is, the agent 102A may calculate a preference to achieve a specific collective objective (or a sub-objective of the collective objective) based on its local sensors (not shown in FIG. 1) and poll the nearby agents 102 in the same and/or different team of the agent 102A for the respective opinions from each agent 102 of each consulted team. These respective opinions form into the weighed census generated via the census model between each agent 102 and assist the agent 102A in using the opinion manager engine 240 of FIG. 6 to determine which option is best to achieve the particular collective objective (or sub-objective). Here, agent 102A determined that searching action 282 would be the most effective option to increase (and ideally maximize) the collective reward. To determine the actions to take when performing the searching option 282, the agent 102A may utilize a respective individual-optimization model to evaluate each possible combination of actions (e.g., movement, speed, etc.) to determine the best set of actions to carry out the searching option 282 based on the maximization of the collective reward and efficiency of the agent 102's actions.

Agents 102B and 102C may calculate a preference to achieve a specific collective objective (or a sub-objective of the collective objective) based on the local sensors of agents 102B and 102C and poll the nearby agents 102 in the same and/or different team of the agent 102B and 102C for the respective opinions from each agent 102 of each consulted team. These respective opinions form into the weighed census generated via the census model between each agent 102 and assist the agents 102B and 102C in using the opinion manager engine 240 of FIG. 6 to determine which option is best to achieve the particular collective objective (or sub-objective). Here, agent 102B determined that an exploitation option 284 and agent 102C determined that an exploitation option 286 would each, individually, be the most effective option to increase (and ideally maximize) the collective reward based on the weighted census. To determine the actions to take when performing the exploitation options 284, 286, each agent 102B, 102C (respectively) may evaluate each possible combination of actions (e.g., movement, speed, etc.) via the individual-optimization model to determine the best set of actions to carry out the exploitation options 284, 286 based on the increase of the collective reward and efficiency of the agents 102B, 102C's (respectively) actions.

In some embodiments, environmental changes and/or events may occur which precipitate into an emergency situation. Here, agents 102A, 102B, and 102C either determine or receive an indication of the emergency event. As a result of this indication, the agents 102A, 102B, and 102C may form into a new ad-hoc team focused on migrating to a migration destination 288.

With the foregoing in mind, FIG. 8 illustrates an example scenario 300 in which one or more agents 102A-F are tasked with protecting a high-value target 302 from one or more opposition agents 304. In this example scenario 300, the one or more agents 102A-F have three objectives to achieve at the group level: (1) efficiently patrol the area around the high-value target 302, (2) balance battery level of each agent 102 by rotating agents 102 between patrolling and loitering close to the high-value target 302, and (3) efficiently intercept and interrogate any opposition agents 304. As seen above with respect to example scenario 280, example scenario 300 has three options that the one or more agents 102A-E balance via the census model and associated weighted census. Collective rewards are distributed for achieving various objectives, such as patrolling the area for a certain amount of time, keeping battery consumption below a particular rate, and/or intercepting opposition agents 304. For each agents 102A-E, different options (and thus, different actions) are similarly broadcasted to each other agent 102 to form the weighted census.

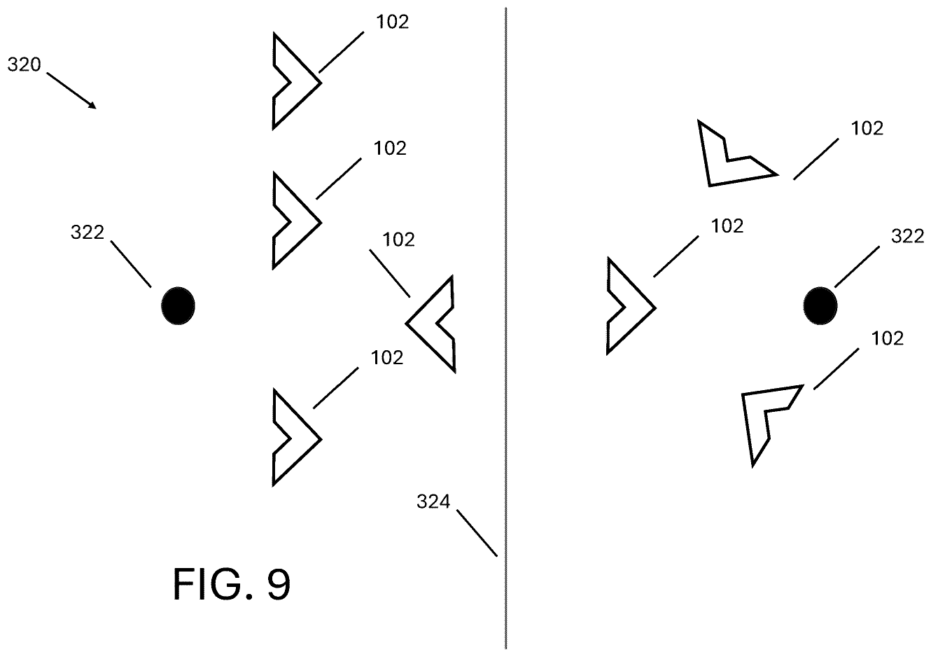

Furthermore, FIG. 9 illustrates an example scenario 320 in which each agent 102 is assigned to a particular team (e.g., red or blue) and tasked with protecting a flag 322. The zones are separated by a line 324 and each agent 102 is presented with one of two options: attack or defend. Collective rewards are distributed for achieving various objectives, such as capturing the flags 322, defending the flags 322, and intercepting attacking agents 102. For each agents 102A-E, different options (and thus, different actions) are similarly broadcasted to each other agent 102 to form the weighted census for each respective team.

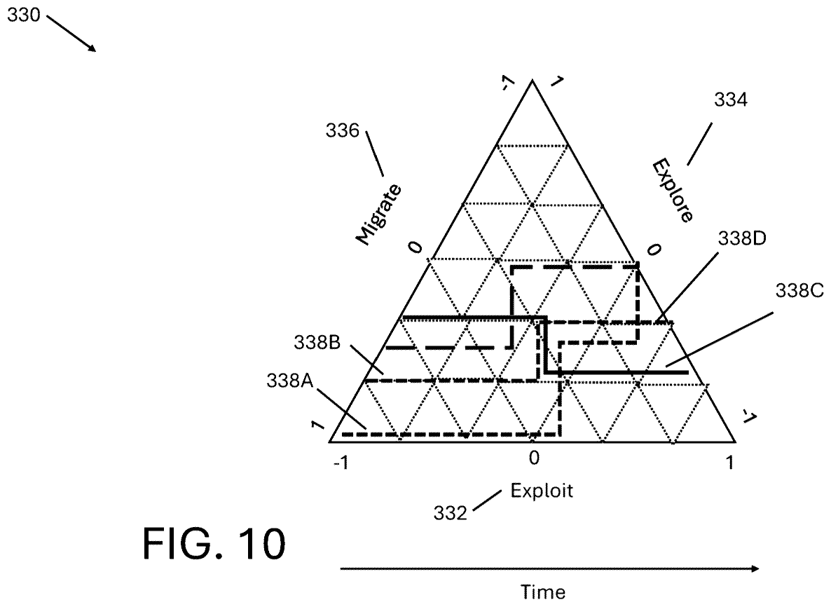

FIG. 10 is a graph 330 illustrating the adaptation of the census model over the course over a period of time. The graph 300 is a simplex graph, which allows for the mapping of the changing opinion with regard to three different options. In the example herein and in FIG. 7, the three axis each represent a different option. A first axis 332 is representative of an exploit option, a second axis 334 is representative of an explore option, and a third axis 336 is representative of a migrate option. Each line 338A-D represents a specific agent 102 and the coordinates of the agent 102 representant the opinion of the agent 102 at a particular point in time. The opinion dynamics update processor 248 may continuously determine the opinion of each agent 102 and chart that continuously updating opinion on the graph 330. Each coordinate is representative of a particular scalar value. Since there are three different axis, coordinates for a specific agent 102 may be represented by three different values. However, to reduce communication load and increase broadcasting speed, each agent 102 may report two scalar values representative of the agent's 102 opinion. That is, for N options, each agent 102 may report N−1 options.

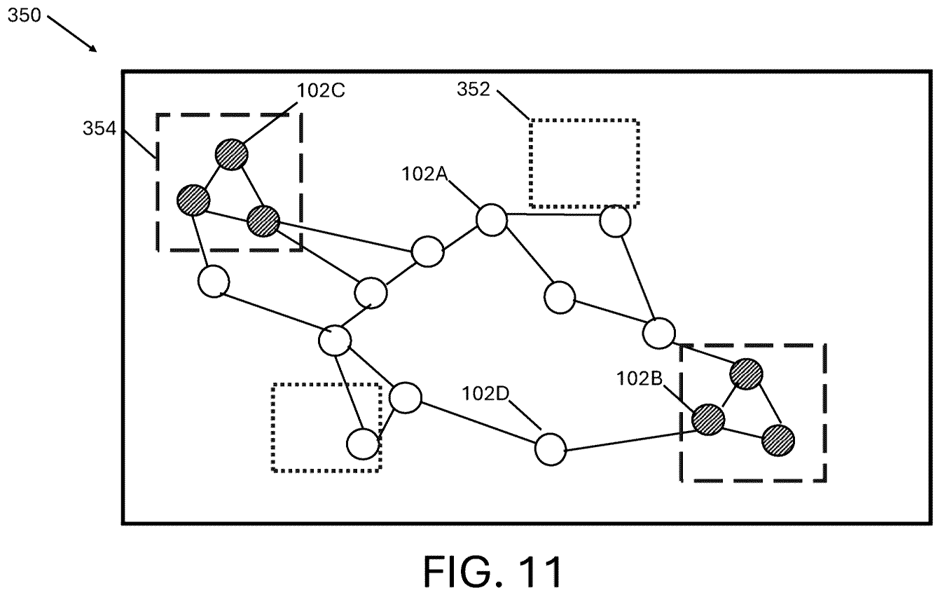

FIG. 11 illustrates a high-level view 350 of the example scenario 280 described in FIG. 7, where the circles with dashed lines (e.g., agents 102B and 102C) represent one or more agents 102 performing the exploit option and the empty circles (e.g., agents 102A and 102D) represent one or more agents 102 performing the search option. As seen by the connecting lines between each agent 102, a network between each of the one or more agents 102 may form, where each agents 102 may communicate (e.g., broadcast) to nearby agents 102 to form a full network. In some embodiments, agents 102A and 102D may form into groups to cooperatively search for unknown patches 352. Furthermore, agents 102B and 102C may form into groups to cooperatively exploit a known patch 354. As illustrated in FIG. 11, exploit groups (e.g., agents 102B and 102C) may lead to the positioning of each agent 102B, 102C closer together to optimally exploit known patches 354. Also illustrated in FIG. 11, search groups (e.g., agents 102A and 102D) may lead to the positioning of each agent 102A, 102D farther apart to capture a larger search area to identify known patches 354 from unknown patches 352.

Various embodiments of the concepts, systems, devices, structures and techniques sought to be protected are described. It should, however, be appreciated that alternative embodiments can be devised without departing from the scope of the concepts, systems, devices, structures and techniques described herein. It is noted that various connections and positional relationships (e.g., over, below, adjacent, etc.) are set forth between elements in the following description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship.

As an example of an indirect positional relationship, references in the present description to forming element or layer “A” over element or layer “B” include situations in which one or more intermediate elements or layers (e.g., element or layer “C”) is between element or layer “A” and element or layer “B” as long as the relevant characteristics and functionalities of element or layer “A” and element or layer “B” are not substantially changed by the intermediate layer(s).

The following definitions and abbreviations are to be used for the interpretation of the claims and the specification. As used herein, the terms “comprises,” “comprising, “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs. The terms “one or more” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection”.

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal, “top,” “bottom,” and derivatives thereof shall relate to the described structures and methods, as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element.

The term “direct contact” means that a first element, such as a first structure or layer, and a second element, such as a second structure or layer, are connected without any intermediary elements or layers at the interface of the two elements or layers.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

The term “substantially equal” may be used to refer to values that are within ±20% of one another in some embodiments, within ±10% of one another in some embodiments, within ±5% of one another in some embodiments, and yet within ±2% of one another in some embodiments.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the concepts, upon which this disclosure is based, may readily be utilized as a basis for the designing of other structures, methods, and systems for carrying out the several purposes/functions of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A method for group-level decision making via a census comprising:
determining, via an agent controller, one or more collective objectives;
calculating, via the agent controller, a preference for each collective objective of the one or more collective objectives, wherein each preference is associated with an internal opinion;
receiving, via the agent controller, an external opinion from each agent of one or more agents to form a weighted census;
updating, via the agent controller, the internal opinion based on the weighted census;
selecting, via the agent controller, an option based on the internal opinion;
selecting, via the agent controller, one or more actions corresponding to the selected option; and
performing, via the agent controller, the one or more actions via the agent controller.

2. The method of claim 1, wherein determining the one or more collective objectives comprises determining the one or more collective objectives via one or more nearby agent of the one or more agents.

3. The method of claim 1, wherein determining the one or more collective objectives comprises receiving the one or more collective objectives from another agent of the one or more agents.

4. The method of claim 1, comprising:
calculating, via the agent controller, utility functions for each action of the one or more actions;
determining, via the agent controller, an pareto optimal solution for the selected option; and
adjusting, via the agent controller, the one or more actions associated with the selected option based on the pareto optimal solution.

5. The method of claim 1, wherein each opinion comprises a positive or negative opinion associated with a particular option.

6. The method of claim 1, comprising determining an optimization mode of a plurality of optimization modes, wherein the plurality of optimalization modes comprise an increase of sampling efficiency with a decrease of dangerous scenarios, competitive-based point collection, increase of intercept efficiency in a high-value as set protection scenario.

7. The method of claim 1, comprising:
detecting, via the agent controller, an indication of an emergency scenario impacting at least one agent of the one or more agents;
transmitting, via the agent controller, the indication of the emergency scenario to each agent of the one or more agents; and
executing, via the agent controller, a transition from normal operation to emergency operation based on the indication.

8. The method of claim 1, wherein each agent is associated with individual parameters and collective parameters, wherein the individual parameters include a current state of operation and an individual behavior optimization value, wherein the collective parameters include the internal opinion and a collective behavior optimization value.

9. The method of claim 1, comprising:
determining, via the agent controller, one or more shared actions based on the weighted census;
determining, via the agent controller, one or more groups to perform a respective shared action, wherein the one or more groups include a subset of the one or more agents; and
communicating, via the agent controller, each respective shared actions to each respective group.

10. A system for group-level decision-making and behavior optimization for individual decision-making, wherein the system comprises:
one or more agents, wherein each agent includes an agent controller and is communicatively coupled to one another, wherein each agent is configured to:
receive sensor data via one or more sensors associated with a respective agent;
generate one or more options based on the sensor data, wherein each option is associated with an action;
generate one or more internal opinions based on the one or more options, wherein each internal opinion is associated with a respective option of the one or more options;
transmit the one or more internal opinions and the one or more options to each agent of the one or more agents;
generate a census for group-level decision-making in combination with the other agents of the one or more agents, wherein the one or more agents communicate with one another via the census to reach a decision on an option to pursue;
select an active option based on the census;
select an action corresponding to the active option; and
perform the action via the agent controller.

11. The system of claim 10, wherein each agent generates the one or more internal opinions via an opinion manager engine.

12. The system of claim 10, wherein each option comprises a plurality of parameters to influence behaviors of the respective agent.

13. The system of claim 10, wherein each agent associates with one another to form one or more groups, wherein each group performs related actions based on the census.

14. The system of claim 13, wherein the one or more agents are configured to:
achieve a census on a selected option based on the census; and
cascade particular opinions to particular groups and each agent within the particular groups.

15. The system of claim 10, wherein each option comprises a desired heading and desired speed.

16. The system of claim 13, wherein the one or more agents are configured to:
generate one or more tasks based on the sensor data; and
allocate a set of tasks to each group, wherein a respective set of tasks includes a subset of the one or more tasks.

17. A method to adaptively change a census model, comprising:
identifying, via an agent controller, a plurality of collective rewards associated with a goal via the census model from one or more agents;
determining, via the agent controller, a first improvement in census model to increase collective rewards;
determining, via the agent controller, a second improvement in an individual optimization model to increase an individual reward, wherein the individual reward is of the plurality of collective rewards;
adjusting, via the agent controller, one or more parameters of the census model based on the first improvement; and
adjusting, via the agent controller, one or more parameters of the individual optimization model based on the second improvement.

18. The method of claim 17, comprising:
identifying, via the agent controller, one or more errors in executed actions associated with a respective agent;
determining, via the agent controller, a third improvement in a control algorithm; and
adjusting, via the agent controller, one or more parameters of the control algorithm based on the third improvement.

19. The method of claim 18, wherein the identification processes are carried out periodically, randomly, in a set order, or any combination thereof.

20. The method of claim 17, wherein the one or more agents include marine robots, terrestrial robots, aerial robots, extraterrestrial robots, digital robots, or any combination thereof.
